(19) United States
(12) Patent Application Publication
(10) Pub. No.: US 2006/0086236 A1
(43) Pub. Date: Apr. 27, 2006

(54) Music selection device and method therefor

(76) Inventor: Michael Lee Ruby, Sandy Valley, NV (US)

Correspondence Address: WEISS & MOY PC, 4204 NORTH BROWN AVENUE, SCOTTSDALE, AZ, 85251, US

(21) Appl. No.: 10/973,842

(22) Filed: Oct. 25, 2004

(51) Int. Cl. G10H 7/00

(52) U.S. Cl. 84/612

(57) ABSTRACT

A method of providing dance music includes receiving a request of a dance type or tempo from a user interface. A song is selected conforming to the request. A device having a user interface, memory, processor, and audio signal generator provides dance music conforming to tempo or dance type requests.

### FIELD OF THE INVENTION

This invention relates generally to dance music, and more particularly, to devices, methods, and software for providing appropriate music selections for dancing.

### DESCRIPTION OF THE RELATED ART

People have danced throughout recorded history, and continue to do so today. In recent American history, dance music and the corresponding dances have evolved with societal trends, including the introduction of mass media such as motion pictures, radios, and television. Prominent examples include swing during the big band era and Latin during the 1940s. Rock n' roll followed, driven by performers such as Bill Haley and His Comets and Elvis. The television show “American Bandstand” brought to the public the latest trends in music, performers, and dances. Couples dancing returned in the 1960s and '70s, including the Hustle and choreographed dances of the Disco era.

Dance is more popular and varied than ever. In the last fifteen years, a revival of big-band and swing dances such as Fox-Trots, Waltzes, and Jitterbugs has swept the nation. Disco has recently regained popularity, and country line dancing, inspired by square dances, has spread from its Southern origins to urban populations nation-wide.

Dance music tends to fit into main categories such as Country, Swing, Latin, Ballroom, and Line. Each main category may have eight to ten different styles, for example, Latin styles include the Cha-Cha, Meringue, Rumba, Salsa, among others. Finally, the tempo of the dance is important to dancers, as beginners typically start with slower tempos, progressing to faster tempos as their skills develop and improve.

Taking into account only major category and styles within each category, there are roughly fifty distinct dance types available for a dancer to learn. Of those, most dancers tend to only know a few well enough to perform. One dilemma that such dancers face is that at three minutes per song, or twenty songs per hour, the dancer may only be able to dance to one or two songs per hour. The rest of the time is spent sitting and waiting for another song. When music selection is provided by Billboard listings, typically the number of danceable songs is-reduced by half or more. Finally, when an appropriate tempo is desired, a dancer may have to wait a very long time before a danceable song is performed.

Such music-related difficulties face the dance industry today. Finding an appropriate location and music for dancers to learn and rehearse dances can be challenging. Similarly, finding a place suitable for an evening of dancing can also be very difficult. Dance instructors face the problem of finding a source of suitable music for the specific needs of each class. Owners of bars or clubs that seek to offer an enjoyable dance experience face similar difficulties providing a source of music that suits the individual desires of the patrons, both to draw in crowds during peak hours, and also to generate customers during off-peak hours that may want to rehearse on a relatively empty dance floor.

Presently, dance music is provided in three primary ways: by disc jockey (DJ); live bands; and jukeboxes. DJs typically provide extended or continuous mixes of songs that share similar tempos and styles. Dancers, however, tend to prefer songs of regular duration, having a definite start and end, in which the dancers may perform a rehearsed dance. Furthermore, although some DJs entertain song requests, the variety of music provided tends to be limited to the preferences of the DJ and influence of the popular media, thus limiting the dancer's ability to perform a range of dances.

Live bands present other difficulties for dancers, including varying the tempo of songs, making it difficult for beginning dancers to adjust. Music selection tends to be based on current popularity or the band's repertoire, and not on whether the song is conducive to dancing. Often, dancers will simply sit through most of live band performance, waiting and hoping that the band will stumble upon a danceable song.

Jukeboxes, being automated and storing a large quantity of songs, appears to be cost- and space-efficient solution for club owners. However, jukeboxes are typically mostly filled with top songs from Billboard listings, with a few new songs added each month. Additionally, jukeboxes typically only provide information for each song such as title, performer, and year of recording. A dancer attempting to select music for particular dance type or tempo essentially must memorize the titles of appropriate songs for each desired dance and then search through hundreds of selections in search of one.

A need therefore exists to provide a device, method, and software for generating dance music having all of the above advantages but none of the disadvantages.

It is an object of the present invention to provide a method of selecting dance music corresponding to a chosen music type or tempo.

It is a further object of the present invention to provide a device for providing dance music corresponding to user requests of music tempo and type.

It is a further object of the present invention to provide a device for providing dance music corresponding to a user selected play list.

It is a further object of the present invention to provide a software product for generating data corresponding to dance music selected by music type or tempo.

It is a further object of the present invention to provide a method for selecting and inserting drops into dance music.

It is a further object of the present invention to provide a method for selecting and inserting general announcements into dance music.

It is a further object of the present invention to provide a method for inserting a voice-over announcement of an upcoming song into dance music.

The present invention satisfies these needs, and provides other, related, advantages.

### SUMMARY OF THE INVENTION

The foregoing objectives are achieved in the music selection device and method therefor.

In accordance with one embodiment of the present invention, a method of providing dance music is disclosed. The method includes receiving a request including at least one of a dance type and a tempo from a user interface. A song is selected in conformity with the request. The dance music includes the selected song.

In accordance with another embodiment, a method of providing dance music is disclosed. It comprises the steps of receiving a first request from a user interface, where the first request includes at least one of a first dance type and a first tempo, and selecting a first song in conformity with the first dance request. A first entry is added to a play list, with the first entry including the first song. A next request is received from a user interface, where the next request includes at least one of a dance type and a tempo, and a next song is selected in conformity with the next dance request. A next entry is added to the play list, with the next entry including the next song. The dance music includes the play list.

In accordance with yet another embodiment, a music selection device is disclosed. It has a processor for executing program instructions, a user interface, an audio signal generator, and a memory coupled to the processor for storing data and program instructions. The data includes song characteristic data, including a tempo and a dance type. The program instructions include program instructions for receiving from the user interface at least one of a tempo selection and a dance type selection, selecting a song corresponding to the received selection, and providing to the audio signal generator data for generating an audio signal for the selected song.

In accordance with still another embodiment, a music selection device is disclosed. It has a processor for executing program instructions, a user interface, an audio signal generator, and a memory for storing data and program instructions. The data includes multiple song lists where each song list includes multiple songs. The program instructions include program instructions for receiving from the user interface a song list selection, selecting a song from the selected song list, and providing to the audio signal generator data for generating an audio signal for the selected song.

In accordance with another embodiment, a computer program product comprising signal-bearing media encoding program instructions for execution within a general-purpose computer having a user interface is disclosed. The program instructions comprise program instructions for receiving from the user interface at least one of a tempo selection and a dance type selection, and selecting a song corresponding to the received selection.

The foregoing and other objects, features, and advantages of the invention will be apparent from the following, more particular, description of the preferred embodiment of the invention, as illustrated in the accompanying drawings.

### BRIEF DESCRIPTION OF THE DRAWINGS

FIG. 1 is an illustration depicting a front perspective view of a device for selecting dance music in accordance with an embodiment of the present invention.

FIG. 2 is an illustration depicting a rear perspective view of the device of FIG. 1 with outer panels removed for view of internal components.

FIG. 3 is a block diagram showing components of the device of FIG. 1 in accordance with an embodiment of the present invention.

FIG. 4 is a flowchart depicting operation of a system as embodied in a method in accordance with an embodiment of the invention.

FIG. 5 is a pictorial diagram depicting graphical output of a user interface for selecting a dance type in accordance with an embodiment of the invention.

FIG. 6 is a pictorial diagram depicting graphical output of a user interface for selecting a dance tempo in accordance with an embodiment of the invention.

### DESCRIPTION OF EMBODIMENTS OF THE INVENTION

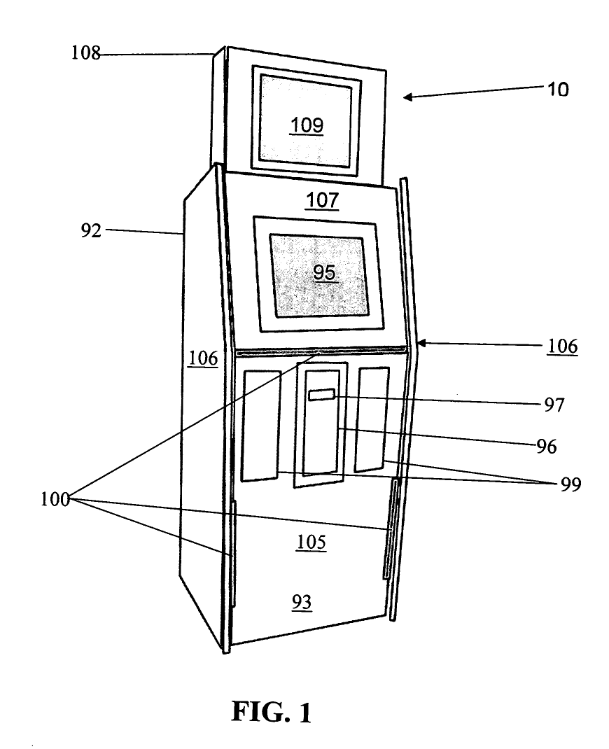

With reference now to the figures, and in particular to FIGS. 1, a music selection device 10 is depicted in accordance with an embodiment of the present invention. Preferably, the music selection device 10 includes a user interface 95 in the form of a touch-screen graphical display mounted to a cabinet 92. As depicted in FIG. 1, the front panel 93 of the cabinet 92 houses a currency acceptor 97 for receiving and authenticating currency. A currency acceptor door 96 allows access to currency that has been accepted by the currency acceptor 97. Speakers 99 may also be housed in the front panel 93. An advertisement display box 108, located at the top of the cabinet 92, houses an advertisement screen 109.

In order to provide an attractive appearance to users of the music selection device, neon lights 100 may be mounted to the front panel 93. In addition, a front upper advertising location 107, front lower advertising location 105, and side advertising locations 106 may be used to provide advertisements or other visual features to the device 10.

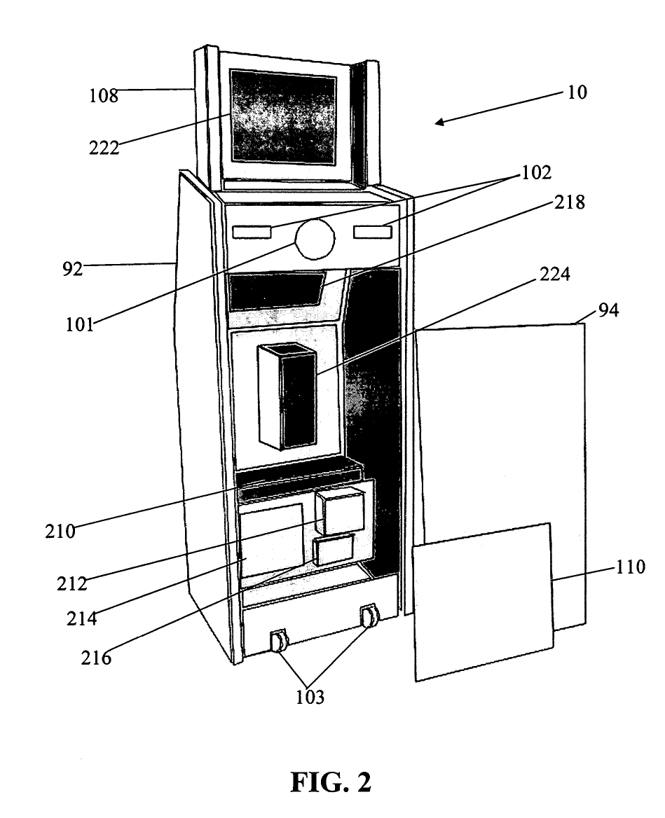

Turning now to FIG. 2, a rear view of the current embodiment of the music selection device 10 is depicted with access panels 94 and 110 removed to show interior components. The cabinet 92 preferably further includes moving handles 102 and wheels 103 for transportation of the music selection device 10.

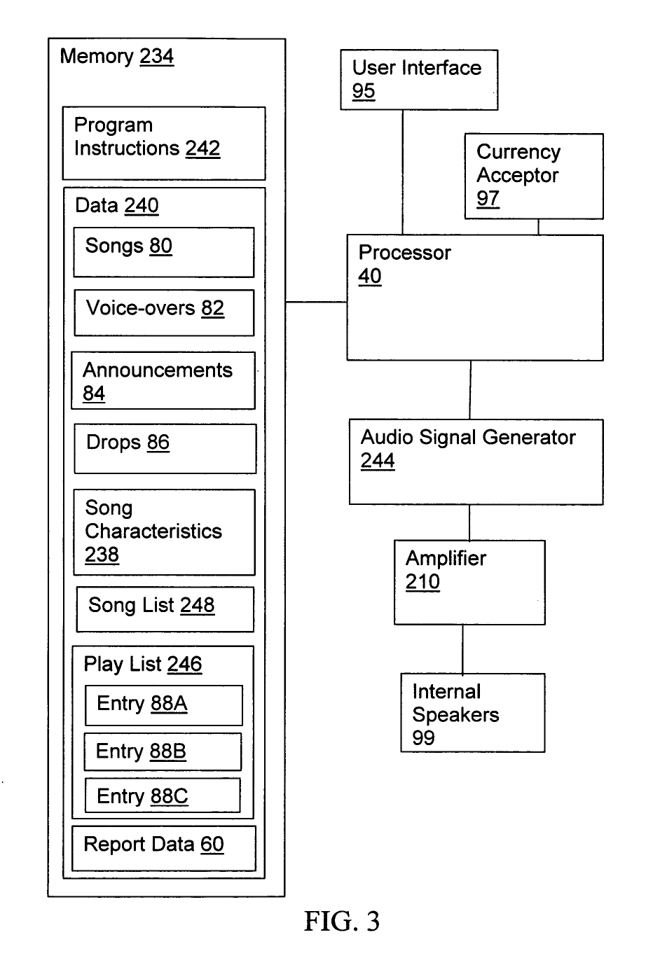

A monitor 222 is inside the advertisement display box 108 for providing images on the advertisement screen 109. Components inside the cabinet 92 include an audio amplifier 210 for powering speaker systems, such as mounted speakers 99 or external speakers (not shown). A monitor 218 provides images for the user interface 95. A bill acceptor housing 224 contains the components of the currency acceptor 97 and stores currency. A central processing board 214 and memory storage unit 216 contain memory 234 (see FIG. 3). The central processing board 214 also contains a processor 40 and an audio signal generator 244 (see FIG. 3). Electronic components are powered by a power supply 212 and cooled by a cooling fan 101.

Turning now to FIG. 3, components of the music selection device 10 of the present invention are depicted, with which methods of the present invention may be practiced. The-components include a memory 234 for storing data 240 and program instructions 242 coupled to a processor 40 for processing the program instructions 242. An audio signal generator 244 is coupled to the processor 40 for generating audio signals. The processor 40 is further coupled to the currency acceptor 97 to provide information about the amount of money that has been received, and to the user interface 95.

The audio signal generator 244 produces an analog signal in response to receiving song data 80 by methods well known in the art and appropriate for the song data 80. For example, if the song data 80 is digital music files, the audio signal generator 244 may include a digital-to-analog converter (DAC). If the song data 80 is compressed digital data, such as in MPEG-3 (MP3) format, the audio signal generator may include a component to reconstruct the compressed data prior to transferring to a DAC. As further examples, the audio signal generator 244 may include a needle for song data 80 stored on vinyl platters, or tape heads for song data 80 stored on magnetic tape.

An amplifier 210 amplifies the audio signal produced by the audio signal generator 244 and transmits the amplified audio signal to the internal speakers 99. However, it is within the spirit and scope of the present invention that music selection device 10 of the present invention not use internal speakers 99, and instead provide the audio signal, or the amplified audio signal, to an external amplifier and speaker system, such as through an audio output jack (not shown). For example, if the music selection device 10 is used in a dance club equipped with a sound system, it may be preferred that the audio signal be transmitted to the dance club's sound system.

In one embodiment, data 240 stored in memory 234 includes song characteristic data 238, including a tempo, a dance type, and a title. Although it is preferred that the songs 80 are also stored as digital files in memory 234, it is within the spirit and scope of the present invention that the songs 80 may not be stored as digital files in memory 234, and instead may be retrieved from a remote storage location such as the public Internet or a local network via a network connection or wireless interface. A network interface, such as a wireless or physical cable interface (not shown) may be provided to facilitate the transfer of digital files, to the device to facilitate retrieval or storage of data. It should be clearly understood that the songs 80 may be stored in any digital music file format, and may be compressed such as using MPEG-3 (MP3) protocol or any other compression protocol, as long as the audio signal generator 244 is capable of translating received data into an audio signal. In addition, although it is preferred that the songs are stored as digital files, it should be understood that certain benefits may be obtained having songs stored in an analog format. Examples include cassettes, vinyl records, or any other analog format.

The program instructions 242 stored in memory 234 and executed by the processor 40 operate the music selection device 10 in accordance with methods of the present invention. The user interface 95 receives from a user a request specifying desired song characteristics, including at least one of a tempo selection and a dance type selection. A song is selected that corresponds to the selection received from the user interface 95, and data is provided to the audio signal generator 244 for generating an audio signal for the selected song.

Preferably, the song characteristic data 238 provides groups of songs 80 in memory 234 according to combinations of both tempo and type, so that a song 80 corresponding to a user request may be quickly selected. The groups may be in the form of lists of pointers, for example, each pointer locating a memory address of a song 80 having characteristics of the particular group. A song 80 may be selected form a group in various ways, such as, for example: randomly, sequentially, or random selection from all songs in the group that have not yet been played, to minimize repetition of songs. However, it should be understood that separate groups of songs need not be used, as long as songs 80 are selectable by tempo and type. For example, tempo and type data for each song 80 may be stored in memory 234 along with the song data 80, and the song data 80 may be searched for a song matching a user request.

Because songs may be selected by users more rapidly than the selected songs are played, the data in stored in memory 234 preferably further includes an ordered play list 246 of entries 88, where the ordered play list 246 has a beginning and an end. When a song is selected, an entry 88 is added to the end of the play list 246 designating the selected song. To play selections in order, the current entry 88 of the play list 246 is located and data for generating an audio signal for the song designated by the current entry 88 of the play list 246 is provided to the audio signal generator 244. A next entry 88 is then located.

The entries 88 of the play list 246 may contain the actual song data 80, or may contain data for locating the song data 80. For example, an entry 88 may contain a pointer to a location in memory 234 occupied by the designated song data 80. As another example, if the music selection device 10 is connected to the public Internet, an entry 88 may contain data for locating the designated song data on the Internet, such as by providing a URL and song title to retrieve song data 80 from a website.

Preferably, the data 240 stored in memory 234 further includes one or more pre-recorded drops 86 for providing a short and catchy transition between songs, such as “Playing your requests all day and night with the music selection device.” Preferably, a drop 86 is selected for each entry 88 of the play list 246, and data designating the selected drop 86 is added to each entry 88, either by adding the drop 86 directly to the entry 88, or by proving data for locating the selected drop 86 to the entry. Data for generating an audio signal for the pre-recorded drop 86 designated by an entry 88 is provided to the audio signal generator 244 so that a drop 86 is played between songs designated by sequential entries 88 in the play list 246.

The drops 86 may be selected randomly or pseudo-randomly, such as by using an output of a random number generator (not shown), or may be selected in conformity with one or more predetermined algorithms, such as a sequential selection, or a cycle of random selections of all drops 86 that have not yet been played and repeating the cycle when all have been played once. Although it is preferred that several pre-recorded drops 86 are provided so that each entry 88 of the play list 246 designates a drop 86 with minimal repetition, it should be understood that certain benefits may be obtained by not having several, or any, pre-recorded drops 86. For example, a live announcer may provide drops between songs. Furthermore, certain benefits may be obtained by not selecting a pre-recorded drop 86 for each entry 88, and instead only selecting a pre-recorded drop 86 intermittently; for example: every second entry 88, or every third entry 88.

Preferably, the data 240 stored in memory 234 further includes one or more pre-recorded general announcements 84 for announcing information of interest, such as drink specials, upcoming events, or advertisements for products or services. Preferably, an announcement 84 is selected for each entry 88 of the play list 246, and data designating the selected announcement 84 is added to each entry 88, either by adding the announcement 84 directly to the entry 88, or by proving data for locating the selected announcement 84 to the entry. Data for generating an audio signal for the pre-recorded announcement 84 designated by an entry 88 is provided to the audio signal generator 244 so that an announcement 84 is played between songs designated by sequential entries 88 in the play list 246. Announcements 84 may also be recorded or provided with conventional methods such as, for example, a microphone coupled to the device via a microphone jack (not shown).

The pre-recorded general announcements 84 may be selected randomly or pseudo-randomly, such as by using an output of a random number generator (not shown), or may be selected in conformity with one or more predetermined algorithms, such as a sequential selection, or a cycle of random selections of all pre-recorded general announcements 84 that have not yet been played and repeating the cycle when all have been played once. Although it is preferred that several pre-recorded general announcements 84 are provided-so that each entry 88 of the play list 246 designates a pre-recorded general announcement with minimal repetition, it should be understood that certain benefits may be obtained by not having several, or any, pre-recorded general announcements 84. For example, a live announcer may provide general announcements between songs. Furthermore, certain benefits may be obtained by not selecting a pre-recorded general announcement 84 for each entry 88, and instead only selecting a general announcement 84 intermittently; for example: every second entry 88, or every third entry 88.

Preferably, a voice-over announcement 82 is provided during each song announcing the song to be played next, so that listeners may anticipate the upcoming song. For example, listeners may choose to enter a dance floor to dance to the upcoming song, or dancers may choose to leave the dance floor at the end of the current song. The voice-over announcements 82 may designate the title of the next song, or the next song type or tempo, or any preferred combination. Examples of voice-over announcements 82 include: “Coming up next, a slow waltz: Tennessee Waltz;” “Next up, a fast cha-cha;” or “salsa is next.” Each voice-over announcement 82 may be stored as a digital file and provided to the audio signal generator 244 for generating a voice-over announcement for the next song during a song that is playing.

As one of ordinary skill in the art will recognize, the addition of voice-over announcements 82 may be achieved in a variety of ways. As an example, pre-recorded voice-over announcements 82 may be stored in memory 234 for each song that may be selected. When a new entry 88 is added to the end of the play list 246, a pointer to a memory location of the voice-over announcement 82 for the song designated by the new entry 88 is added to the previous, or next-to-last, entry 88 in the play list 246. When an entry 88 becomes the current entry 88 on the play list 246, the voice-over announcement 82 is located in memory 234 and provided to the audio signal generator 244. The audio signal generator 244 then mixes the voice-over announcement 82 with the song 80 designated by the current entry 88, to provide an announcement 82 of the next song.

However, variations from the above example that result in a voice-over announcement 82 of a next song during a current song should be understood to be within the spirit and scope of the present invention. For example, an entry 88 of the play list 246 may contain actual voice-over announcement 82 data instead of a pointer to a memory location, to reduce memory access time while a song is played. As another example, instead of the audio signal generator 244 receiving both the voice-over announcement 82 and the current song and mixing the both, the voice-over announcement 82 may be mixed with the song data 80 by the processor 40 and the mixed digital file stored in a play list 246 entry 88, or may be mixed by the processor 40 just prior to providing the song data to the audio signal generator 244. Alternatively, the voice-over announcement may be generated in real time without storing voice-over data in memory 234 by using a speech synthesizer (not shown).

Finally, it should be understood that certain benefits may be obtained by not providing voice-over announcement 82 at all. For example, if the music selection device 10 is used in a dance instruction studio for teaching students, the utility of announcing a next song may be outweighed by additional cost or complexity of providing voice-over announcements.

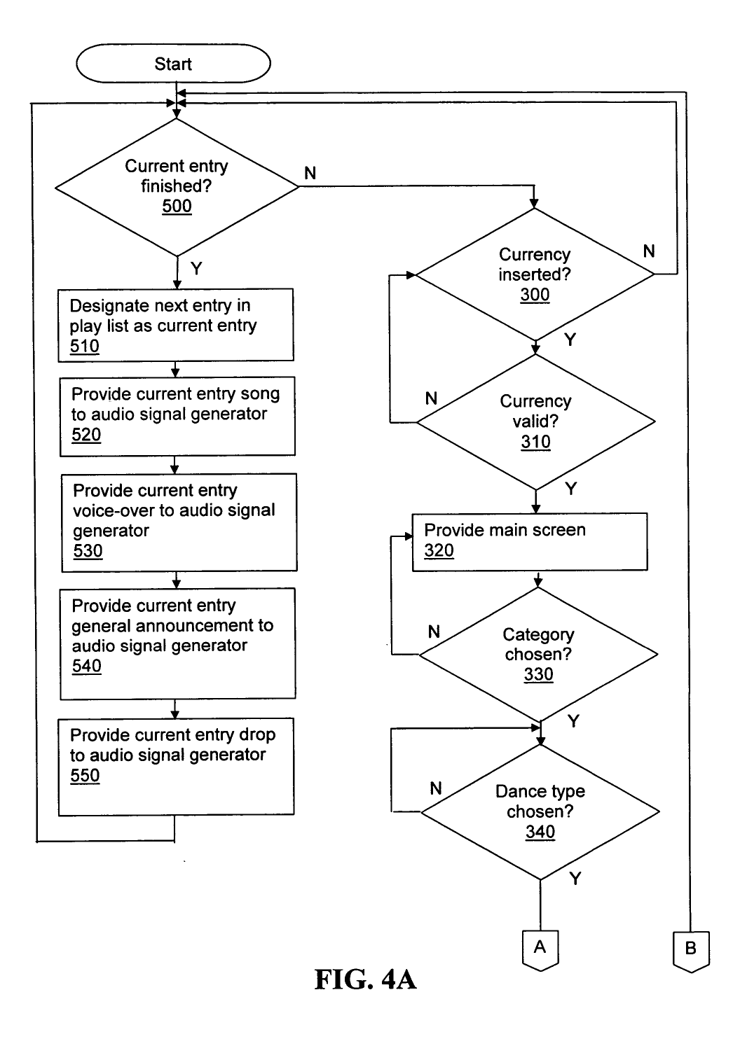

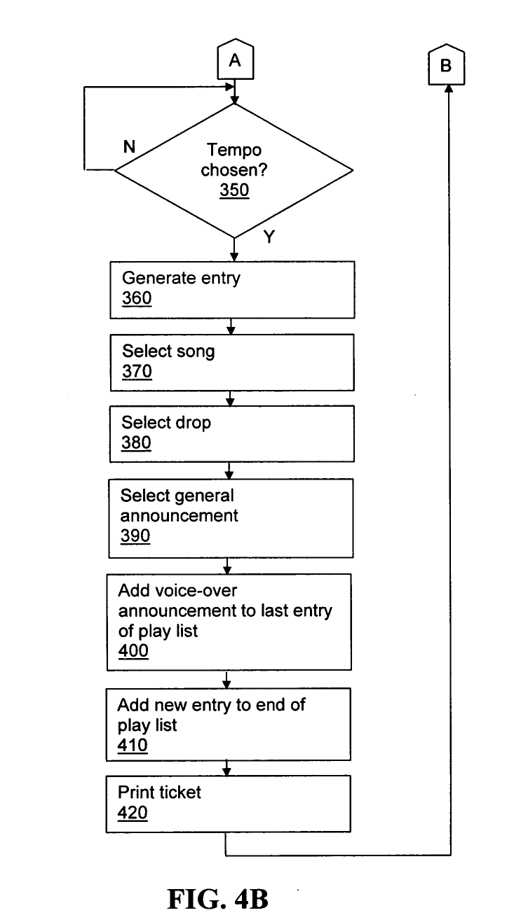

Turning now to FIGS. 4A-B, a flowchart depicts methods of the present invention that may be practiced by the music selection device 10. A user provides monetary value (step 300) that is authenticated (decision 310). The monetary value may be currency in the form of bills or coins, value tickets, credit cards or check cards, hotel room key cards designating a guest account, or any other method or combination of methods of providing monetary value.

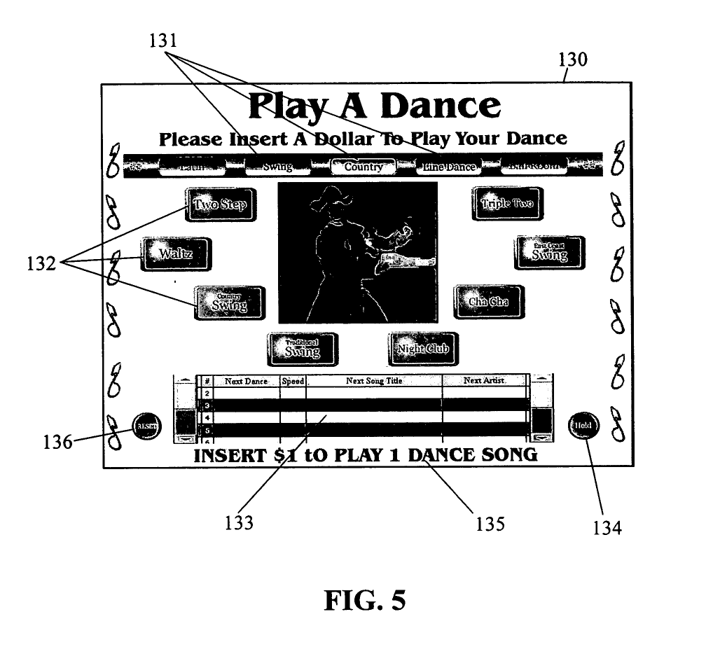

When monetary value has been authenticated, a user interacts with a main screen 130 on the user interface 95 (step 320). FIG. 5 depicts an example of a main screen 130 showing major dance categories selection controls 131, such as Latin, Swing, Country, Line Dance, and Ball Room. A play list of upcoming songs 133 and credit indicator 135 are presented. Additionally, a reset control 134 and pause control 136 may be provided for users to reset their selection or to pause an operation of the device 10.

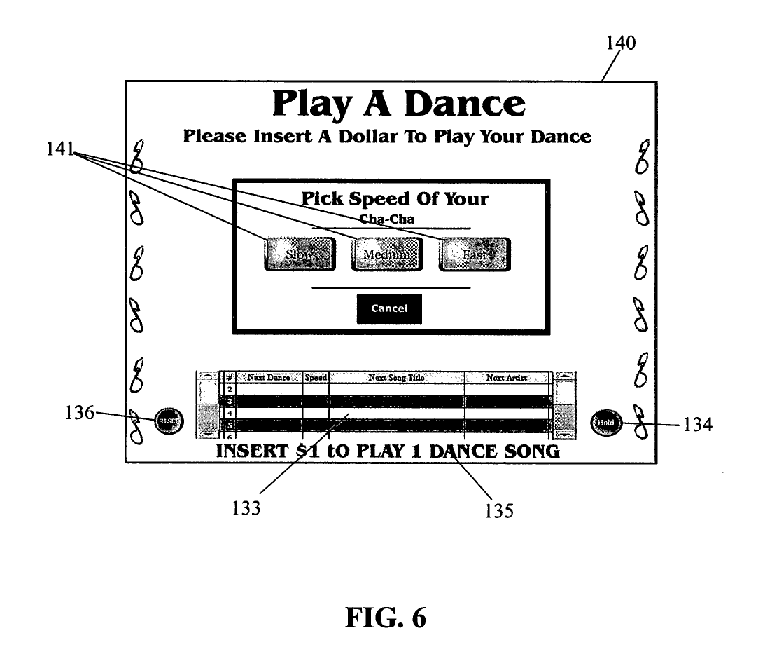

When a major dance category is selected, preferably by interacting with a touch-screen overlay (although any method of interaction may be incorporated, such as a pointing device, keyboard, or voice recognition, for example) (decision 330), appropriate controls 132 for selecting dance types corresponding to the selected major dance category are displayed. When a dance type is selected (decision 340), the user is prompted to select a dance tempo. FIG. 6 depicts an example of a user interface display prompting for a tempo selection 140. Tempo selection controls 141 are provided for a user to select a desired tempo for the selected dance type. However, it-should be understood that certain benefits may be obtained by not providing a tempo selection prompt 140, such as when a dance type tends to be constrained to a particular tempo. For example, some Line Dance types tend to be preformed using only tempos corresponding to the original choreography of the dance.

When a tempo is selected (decision 350), the user requested dance type and tempo are used to create a new entry 88 for the play list 246 (step 360). A song 80 is selected corresponding to the user request and data designating the selected song 80 is stored in the new entry 88 (step 370). A pre-recorded drop 86 is selected and data designating the selected pre-recorded drop 86 is stored in the new entry 88 (step 380). A pre-recorded general announcement 84 is selected and data designating the selected pre-recorded general announcement 84 is stored in the new entry 88 (step 390). A voice-over announcement 82 corresponding to the song selected for the new entry 88 is selected and added to the entry 88 currently at the end of the play list 246 (step 400). Finally, the new entry 88 is added to the end of the play list 246 (step 410), and a receipt is printed and returned to the user, either via the currency validator system 97 or by other hardware. The receipt may include coupons for goods or services, further advertisements, or any other desired material. Further, it is contemplated by the present invention that a receipt may function to store value for later use by the music selection device 10 or other devices, such as with commonly-known “ticket-in ticket-out” systems.

When the current entry 88 of the play list 246 is finished (decision 500), meaning that the song, voice-over announcement, drop, and general announcement designated by the current entry 88 have-been provided to the audio-signal generator 244, the information contained in the current entry 88 is stored in memory as report data 60 for later retrieval and use in reporting functions.

Next, the next entry 88 of the play list 246 is designated as the current entry 88 (step 510). The audio signal generator 244 is provided with the song 80 (step 520) and voice-over announcement 82 (step 530), if provided, of the current entry 88. The general announcement 84 designated by the current entry 88, if any, is provided to the audio signal generator 244 (step 540), as well as the drop 86, if any, designated by the current entry 88 (step 550).

In accordance with another embodiment of the present invention, the music selection device 10 includes a processor 40 for executing program instructions 242, a user interface 95, an audio signal generator 244, and memory 234 coupled to the processor 40 for storing data 240 and program instructions 242. The data 240 in memory 234 includes multiple song lists 248, and each said song list 248 designates multiple songs. The program instructions 242 include instructions for receiving from the user interface 95 a song list selection, selecting a song 80 from the song list 248 that is selected, and providing to the audio signal generator 244 data for generating an audio signal for the selected song 80.

Play lists 246 designate a subset of available songs 80 that are available for selection when the play list 246 is chosen. For example, a dance instructor teaching a beginners' waltz class may select a play list designating only slow waltz songs 80. By selecting the slow waltz list, the instructor is assured that appropriate music will be continuously played during the class without further intervention. The sequence of songs played from a selected song list 248 is preferably determined randomly (or pseudo-randomly) from songs that have not yet been played, although any method of determining the play sequence may be used. If the music selection device is used for multiple classes, multiple song lists 248 may be presented as options on the user interface 95.

Although the above example depicts song lists 248 designating songs 80 sharing both a common type and tempo, it should be understood that song lists 248 may designate any songs 80 that are desired. For example: a dance instructor may desire a song list 248 that designates songs of a single type, but of various tempos; or a song list 248 may designate songs of a single tempo but of various types. Finally, a song list 248 may designate songs that have no apparent correlation with tempo or type. For example, a stage performer may select individual songs 80 for a song list 248, so that only songs will be played for which the performer has prepared a performance, or perhaps that the performer has determined obtains beneficial results from an audience.

The song lists 248 may be created or edited via the user interface 95. For example, a user creating or editing a song list 248 may be prompted to enter a title for the list, and select either song tempo, or song type, or other song characteristics (such as date of release), or simply select from a list of song titles available in memory 234. User authentication may be provided, such as password protection of song lists 248 and enabled via the user interface 95 as a touch-screen keypad, or any other means well known to those of ordinary skill, to ensure list integrity.

It is contemplated that methods of the present invention may be performed a computer program product having signal-bearing media encoding program instructions for execution within a general-purpose computer having a user interface. For example, the computer program product may be software installable on a computer for allowing a user to perform methods of the present invention to select music. The program instructions provide instructions for receiving from the user interface at least one of a tempo selection and a dance type selection, and then selecting a song corresponding to the received selection. Further, the program instructions may further include instructions for maintaining an ordered list of songs that are selected, providing drops, general announcements, and voice-over announcements of the next song to be played. Songs selected in accordance with methods of the present invention may be played by the computer, such as via an internal speaker, or via a sound card and external speakers, or may be saved to memory or removable media (such as a CD, memory stick, flash drive, as examples) for transmission via electronic methods or physical transport to a playing device.

While the invention has been particularly shown and described with reference to the preferred embodiments thereof, it will be understood by those skilled in the art that the foregoing and other changes in form, and details may be made therein without departing from the spirit and scope of the invention.

What is claimed is:

1. A method of providing dance music, comprising the steps of:
receiving from a user interface a first request, said first request comprising at least one of a first dance type and a first tempo; and
selecting a first song in conformity with said first dance request.

2. The method of claim 1, further comprising the step of locating a first plurality of songs conforming with said first request, wherein said selecting is performed by randomly selecting said first song from said first plurality of songs.

3. The method of claim 1, further comprising the step of providing a pre-recorded drop, wherein said dance music further comprises said pre-recorded drop following said first song.

4. The method of claim 1, further comprising the step of providing a pre-recorded general announcement, and wherein said dance music further comprises said pre-recorded general announcement.

5. The method of claim 1, further comprising the steps of:
receiving from said user interface a second request, said second request comprising at least one of a second dance type and a second tempo;
selecting a second song in conformity with said second request; and
providing an announcement for said second song, wherein said dance music further comprises:
said second song following said first song; and
said announcement for said second song during said first song.

6. A method of providing dance music, comprising the steps of:
receiving a first request from a user interface, said first request comprising at least one of a first dance type and a first tempo;
selecting a first song in conformity with said first dance request;
adding a first entry to a play list, said first entry comprising said first song;
receiving a next request from a user interface, said next request comprising at least one of a dance type and a tempo;
selecting a next song in conformity with said next dance request; and
adding a next entry to said play list, said next entry comprising said next song, wherein said dance music comprising said play list.

7. The method of claim 6, further comprising the steps of:
providing a drop; and
adding said drop to said first entry to said play list, whereby said dance music further comprises said drop.

8. The method of claim 6, further comprising the steps of:
providing an announcement for said next song; and
adding said announcement for said next song to said first entry to said play list, wherein said dance music further comprises said announcement for said next song during said first song.

9. The method of claim 6, further comprising the steps of:
providing a pre-recorded general announcement; and
adding said pre-recorded general announcement to said first entry to said play list, whereby said dance music further comprises said pre-recorded announcement.

10. The method of claim 6, further comprising the steps of:
designating said first entry of said play list as a current entry;
playing said current entry; and
after playing said current entry, designating the next entry of said play list as said current entry.

11. A music selection device, comprising in combination:
a processor for executing program instructions;
a user interface;
an audio signal generator; and
a memory coupled to said processor for storing data and said program instructions, said data comprising song characteristic data, said song characteristic data comprising a tempo and a dance type, wherein said program instructions comprising:
program instructions for receiving from said user interface at least one of a tempo selection and a dance type selection;
program instructions for selecting a song corresponding to said selection that is received; and
program instructions for providing to said audio signal generator data for generating an audio signal for said song that is selected.

12. The device of claim 11, wherein said data further comprising an ordered play list of entries, said ordered play list having a beginning and an end, wherein said program instructions further comprising:
program instructions for adding an entry to the end of said play list, said entry comprising data designating said song that is selected;
program instructions for locating a current entry of said ordered play list;
program instructions for providing to said audio signal generator data for generating an audio signal for the song designated by said current entry of said play list; and
program instructions for locating a next entry of said ordered play list after providing to said audio signal generator said data for generating said audio signal for said song designated by said current entry of said play list.

13. The device of claim 12, wherein said data further comprising a pre-recorded drop, wherein said program instructions further comprising:
program instructions for adding data designating said pre-recorded drop to an entry of said play list; and
program instructions for providing to said audio signal generator data for generating an audio signal for said pre-recorded drop.

14. The device of claim 12, wherein said data further comprising a pre-recorded general announcement, wherein said program instructions further comprising:
program instructions for adding data designating said pre-recorded general announcement to an entry of said play list; and
program instructions for providing to said audio signal generator data for generating an audio signal for said pre-recorded general announcement.

15. The device of claim 12, wherein said program instructions further comprising program instructions for providing to said audio signal generator data for generating an audio signal comprising a voice-over announcement during said song designated by said current entry of said play list, wherein said voice-over announcement provides information corresponding to the song designated by said next entry of said play list.

16. A music selection device, comprising in combination:
a processor for executing program instructions;
a user interface;
an audio signal generator;
a memory coupled to said processor for storing data and said program instructions, said data comprising a plurality of song lists wherein each said song list comprises a plurality of songs, wherein said program instructions comprising:
program instructions for receiving from said user interface a song list selection;
program instructions for selecting a song from said song list that is selected; and
program instructions for providing to said audio signal generator data for generating an audio signal for said song that is selected.

17. A computer program product comprising signal-bearing media encoding program instructions for execution within a general-purpose computer having a user interface, wherein said program instructions comprise program instructions for:
receiving from said user interface at least one of a tempo selection and a dance type selection; and
selecting a song corresponding to said at least one selection that is received.

18. The computer program product of claim 17, wherein said program instructions further comprise program instructions for maintaining an ordered list of songs that are selected.

19. The computer program product of claim 18, wherein said program instructions further comprise program instructions for adding to each song of said ordered list of songs a voice-over announcement of the next song of said ordered list of songs.

20. The computer program product of claim 17, wherein said program instructions further comprise program instructions for adding a drop following said song that is selected.

21. The computer program product of claim 17, further comprising program instructions for adding a pre-recorded general announcement following said song that is selected.
